(19) United States
(12) Patent Application Publication
(10) Pub. No.: US 2004/0123298 A1
(43) Pub. Date: Jun. 24, 2004

(54) Distributed resource allocation mechanism

(76) Inventor: Michael C. Shebanow, Saratoga, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/459,233

(22) Filed: Jun. 11, 2003

Related U.S. Application Data
(63) Continuation-in-part of application No. 10/327,262, filed on Dec. 20, 2002.

(51) Int. Cl. G06F 1/04; G06F 9/00

(52) U.S. Cl. 718/104; 713/500

(57) ABSTRACT

A system and method for performing dynamic resource allocation. A deallocation block sends batons to an allocation block representing assigned resources. The allocation block receives the assigned resources and, if needed, allocates the assigned resources to an execution machine that preforms tasks such as executing instructions. The deallocation block continually sends batons independent of the allocation block's current need for resources. The deallocation returns unused batons or sends used an indication of used batons to the deallocation block. The deallocation block is physically decoupled and distributed from the allocation block.

### CROSS REFERENCE TO RELATED APPLICATIONS

This application is a continuation-in-part to U.S. patent application Ser. No. 10/327,262, filed on Dec. 20, 2002, entitled “Distributed Resource Allocation Mechanism,” from which priority is claimed under 35 U.S.C. § 120 and which application is incorporated by reference herein in its entirety.

### BACKGROUND OF THE INVENTION

1. Field of the Invention

The present invention relates generally to computer processors, and more particularly, to resource allocation within a computer processor.

2. Background Art

In a high clock rate, highly pipelined dynamically scheduled processor, a major problem is how to manage dynamically allocatable resources. For example, a reorder buffer may have 32 entries while a processor is capable of issuing 128 instructions. Since technically each instruction could write a register, a buffer entry could be required for each instruction. However, building a 128 entry buffer would not be practical. Thus, there is a need to dynamically allocate buffer entries only to those instructions that actually need an entry.

One problem of dynamic resource allocation is where to locate the resource allocation and deallocation logic. Typically, multiple logic control points that are widely physically dispersed participate in allocation (e.g., issue logic) and deallocation (e.g., commit logic). For example, with buffer entries, allocation is performed by a DECODE unit which decides if an instruction which consumes a buffer entry is to be issued or not.

In one approach, deallocation logic is located near the deallocation control point and allocation logic is located near the allocation control point. Deallocation occurs when either a checkpoint backup occurs or when an instruction is confirmed, thereby freeing up its buffer entry. However, because deallocation occurs at distributed location from the allocation block, reallocation of the resource is delayed by the time of flight. Thus, there is a need to reduce the time of flight delay associated with resource deallocation and allocation.

In another approach, a centralized location is used to control the allocation and deallocation. The central allocation/deallocation block is located between the blocks the allocation and deallocation control points. However, when the blocks communicate in a high clock rate processor, timing issues remain from the associated time of flight delays.

Accordingly, it is desirable to address the above problems in allocating and deallocating resources in a processor. This solution should provide dynamic allocation and deallocation of resources in a distributed environment while meeting increasing timing requirements.

### SUMMARY OF THE INVENTION

The present invention meets these needs by representing distributed resources in a processor as a set of batons used to dynamically allocate the resources. A deallocation block, such as a central reservation station, deallocates and keeps centralized control of available resources. An allocation module, such as a DECODE unit, allocates resources while being physically decoupled from the deallocation block. The resources may be registers, reorder buffers, or the like, in an execution machine such as an ALU (Arithmetic Logic Unit).

In one embodiment, the deallocation block sends one or more batons representing available resource(s) to the allocation module each clock cycle in anticipation of the allocation module's resource needs. Preferably, the allocation block always has a sufficient amount of batons on hand. The number of batons in flight increases with the distance between the deallocation and allocation blocks as in flight batons may be temporarily stored in buffers between clock cycles. The allocation block receives the batons each clock cycle. In one embodiment, the available batons are represented with an assigned vector.

During the following clock cycle, if the allocation block needs resources, the allocation block can either use the batons received during the previous clock cycle or batons received during an earlier clock cycle to allocate corresponding resources. The allocation block may also send unused batons back to the deallocation module, which can be the batons received during the preceding or earlier clock cycles. In one embodiment, the allocated batons are represented with a used vector.

By using two decoupled block to control allocation and deallocation, one can be located near the allocation control point and the other near the deallocation control point. Advantageously, the allocation block always has resources to allocate to the execution machine without delay or clock rate issues.

### BRIEF DESCRIPTION OF THE DRAWINGS

FIG. 1 is a block diagram illustrating a resource allocation system in a processor according to one embodiment of the present invention.

FIG. 2 is a logic diagram illustrating the deallocation block in accordance with a first embodiment of the present invention.

FIG. 3 is a logic diagram illustrating deallocation block in accordance with a second embodiment of the present invention.

FIG. 4a is a timing diagram illustrating a first baton path in accordance with one embodiment of the present invention.

FIG. 4b is a timing diagram illustrating a second baton path in accordance with one embodiment of the present invention.

FIG. 5 is a flow diagram of a method for baton passing in accordance with one embodiment of the present invention.

### DETAILED DESCRIPTION OF THE INVENTION

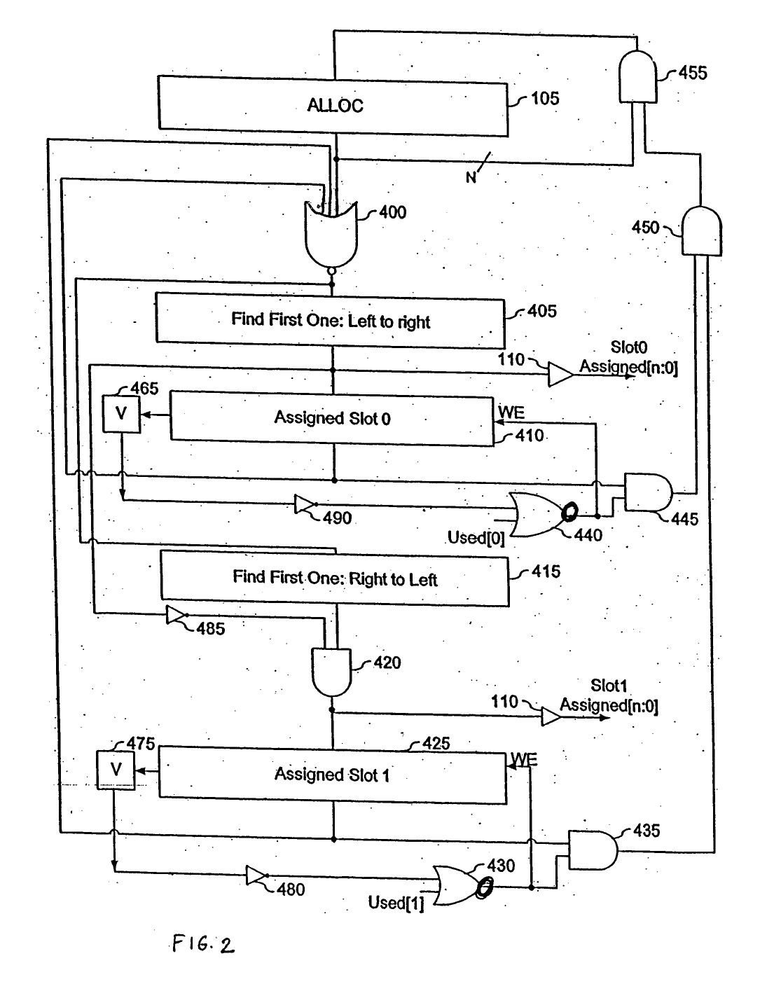

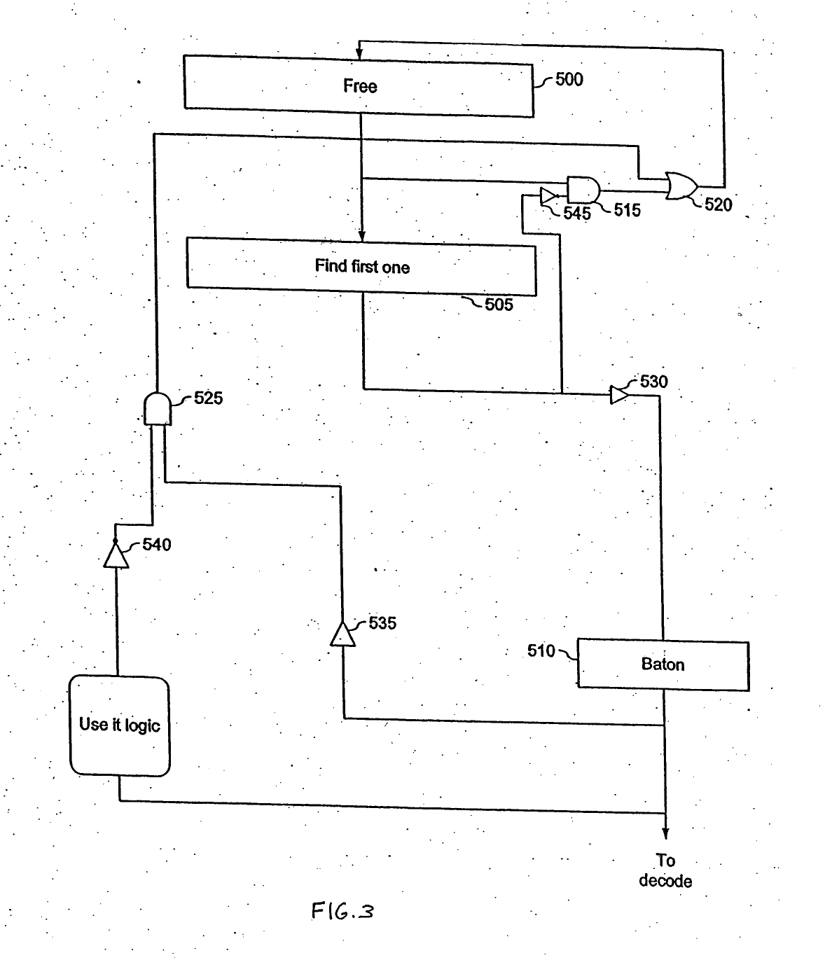

The following description of preferred embodiments of the present invention is presented in the context of resource allocation for use in, for example, a computer processor. In some embodiments, the invention may be implemented with the logic shown in FIG. 2 or 3. However, one skilled in the art will recognize that the present invention may be implemented in many other logic blocks, hardware, software, or firmware. Logic as used herein refers to computer logic embodied in hardware, software, firmware, or a combination thereof.

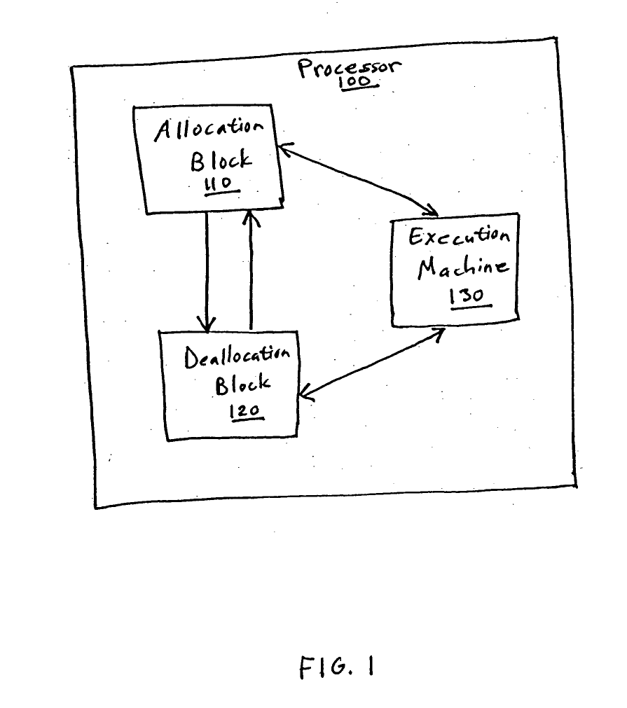

FIG. 1 is a block diagram illustrating a system for resource allocation in a processor. The processor 100 includes an allocation block 110, a deallocation block 120, and an execution machine 130, each of which is coupled in communication. The processor 100 executes code in a computer system. In one embodiment, the processor 100 is a highly pipelined dynamically scheduled 128-bit processor.

The deallocation block 120 may be a CRS unit or any other component capable of dynamically allocating resources in a processor 100. The deallocation block 110 is located near deallocation control points such as commit logic associated with the execution machine 130 and receives notification of freed up resources. The deallocation block 110 maintains available resources, or batons, in a table or other format. The deallocation block 110 assigns and sends resources to the deallocation block 120 each clock cycle. The deallocation block 120 also receives unused resources from the allocation block 110. Methods operating within the deallocation block 120 are discussed below.

In one embodiment, the deallocation block 120 sends enough batons such that the allocation block 110 always has batons on hand to perform necessary tasks. As the distance between increases, more batons will be in flight at any particular time. If the distance is two far for a baton to travel during a since clock cycle, it may be stored in a buffer. In another embodiment, the maximum number of batons assigned by the deallocation block 120 coincides with the maximum number of resources used per clock cycle by the allocation block 110.

The allocation block 110 may be a DECODE unit that issues code or any other component needing dynamically allocated resources from the deallocation block 120. The allocation block 110 receives assigned resources from the deallocation block 120 each clock cycle. The allocation block 110 is located near allocation control points such as issue logic. Each clock cycle, the allocation block 110 may use an assigned resource, for example, by loading an instruction into a reorder buffer. The allocation block 110 may also send assigned resources that are unused back to the deallocation block 120. A logic implementation of the allocation block 110 and methods operating therein are discussed below.

The execution machine 130 uses resources to perform tasks in the processor 100. The execution machine 130 may be a ALU, an FPU, or any other processor component capable of executing code in a processor that receives code of tasks to perform from an allocation block. The resource 130 may be a buffer such as a reorder buffer, a cache, or any other dynamically allocatable resource used by an execution machine to perform tasks.

FIG. 2 is a logic diagram illustrating the deallocation block in accordance with the first embodiment of the present invention. The deallocation block 120 comprises an ALLOC register 105, a find first one left to right block 405, an assigned slot 0 register 410, a find first one right to left block 415, an assigned slot 1 register 425, two V registers 465, 475, logic AND gates 420, 435, 445, 450, 455, logic NOR gates 400, 430, 440 logic inverters 480, 485, 490, and a distributed buffer 111. Note the FIG. 2 is merely an exemplary implementation of the deallocation block 120. While the embodiment of FIG. 2 can be used to allocate up to two resources to the allocation block 110, one of ordinary skill in the art will recognize that the logic could be extended to allocate more than two resources, for example, by replicating at least a portion of the logic. One of ordinary skill in the art will also recognize that many other logic blocks could be used to implement deallocation block 110 that keeps track of free or allocated resources and communicates the free or allocated resources to the allocation block 110.

In one embodiment, unary encoding is used to represent the numerals in keeping track of resources. Unary encoding is an encoding technique whereby a number is represented using a set of 1's and 0's. However, unary encoding is different from binary encoding. In unary encoding the number represented is determined based on a position of a 1 in stream of 0's. For example, a 1 in the least significant bit represents the number zero. A 1 in the second least significant bit represents a one. A 1 in the third least significant bit represents a two.

TABLE 1
Unary encoding examples

| Number | Unary encoding |
|---|---|
| 0 | 0000000001 |
| 1 | 0000000010 |
| 2 | 0000000100 |
| 3 | 0000001000 |
| 4 | 0000010000 |
| 5 | 0000100000 |
| 6 | 0001000000 |
| 7 | 0010000000 |
| 8 | 0100000000 |

Unary encoding makes set arithmetic easier to implement because the set arithmetic can be achieved using AND and OR gates. For example, the A OR B logic function is a set union of set A and set B with unary encoded sets. Similarly, the A AND B logic function is a set intersection of set A and set B with unary encoded sets. This property of unary encoding is important because using a resource or passing back a resource can be viewed as set subtraction or set addition.

In the ALLOC register 105, one bit is allocated per resource. In one embodiment, a logic 1 represents a resource allocated. Each cycle a USED [1:0] vector is computed. This vector indicates whether 0, 1, or 2 resources were allocated, as shown in Table

TABLE 2
USED [1:0] vector examples

| USED [1:0] | Meaning |
|---|---|
| 00 | No resources allocated |
| 01 | One resource allocated (slot 0) |
| 11 | Two resources allocated (slot 0 and slot 1) |

In the present embodiment, the assigned slot registers 410, 425 are loaded with available resources. Initially, these registers are reset or are all zeros and their corresponding V bits 465, 475 are also reset. Each V bit 465, 475 is updated on a clock-by-clock basis by union OR-ing the corresponding bits in the assigned slot registers 410, 425 to form a single bit that indicates whether any resource is assigned. Each clock cycle, the allocation block 110 indicates to the deallocation block 120 which of its assigned resource entries it has used, using the USED vector. The used resources are updated using a WE (write enable) for the assigned slot registers 410, 425. Upon update, the contents of the assigned slot registers 410, 425 are merged into the contents of the ALLOC register 105. The NOR gate 400 is used to temporarily remove free resources that have been passed to allocation block 100. Find first one blocks 405, 415 are blocks that find the first unary one in a vector. Find first one: left to right block 405 looks in the unary encoded number and finds the first one on the left, or the most significant one. Find first one: right to left 415 looks in the unary encoded number and finds the first one on the right, or the least significant one. The find first one blocks 410, 415 select the 0, 1, or 2 free resources and make them available to the ALLOC block 105.

FIG. 3 is a logic diagram illustrating deallocation block in accordance with a second embodiment of the present invention. The deallocation block 120 comprises a free register 500, a find first one block 505, a baton 510 (or resource), AND logic gates 515, 525, OR logic gate 520, inverters 535, 540, 545, and buffers 535, 540, 545. In this embodiment, the free register 500 is used to keep track of free resources. In one embodiment, a logic 1 in the free register 500 indicates a free resource and a logic 0 indicates an allocated resource. The free register 500 outputs an N hot number. An N hot number is a unary encoded stream of 1 's and 0's when there are N1's in the stream, N being any integer greater than or equal to one. The find first one block 505 finds the first one. The find first one block 505 outputs a one hot number, meaning that there is only one logic 1 in an output stream of 1's and 0's. The first one indicates the first free resource. The free resource is stored in the baton register 510 and passed to the allocation block 110.

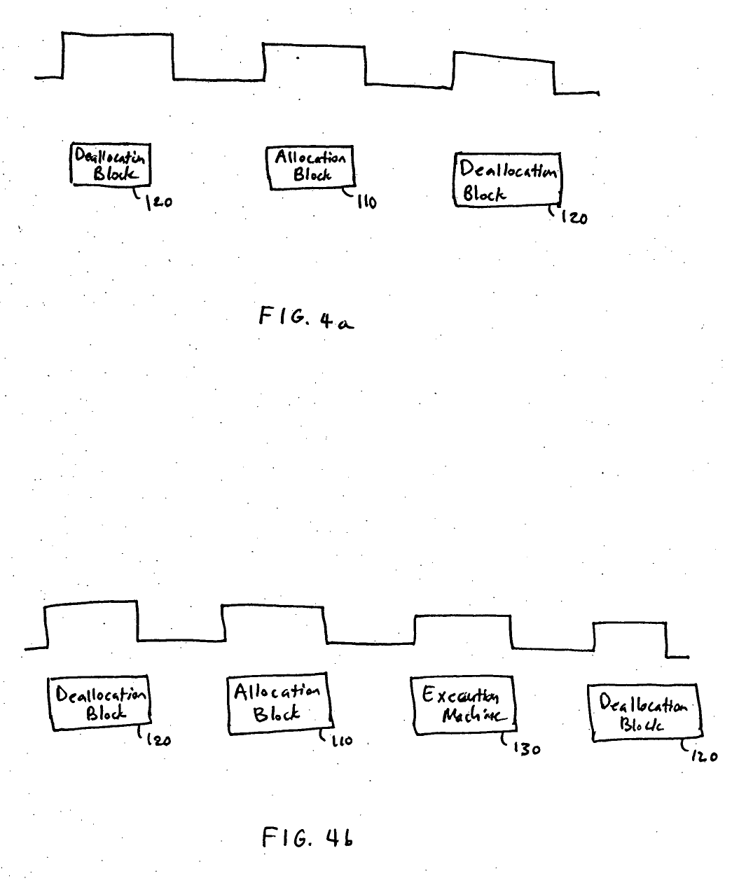

FIG. 4a is a timing diagram illustrating a first baton path in accordance with one embodiment of the present invention. The timing diagram includes the deallocation block 120, and the allocation block 110 along with two clock cycles, one with leading edge 205 and the other with leading edge 210. During a first clock cycle 410a, deallocation block 120 sends one or more batons to the allocation block 110. The deallocation block does not use the assigned resources. Thus, during a second clock cycle 410b, allocation block 110 sends one or more batons back to the deallocation block 110. During the third clock cycle 410c, the deallocation block 110 receives the unused batons. In another embodiment, the unused batons sent back to the deallocation block 120 are batons received before the second clock cycle 410b.

FIG. 4b is a timing diagram illustrating a second baton path in accordance with one embodiment of the present invention. The timing diagram includes the deallocation block 120, the allocation block 110, and the execution machine 130 along with two clock cycles, one with leading edge 205 and the other with leading edge 210. As in FIG. 4a, the deallocation block 120 sends one or more batons to the allocation block 110 during the first clock cycle 410a. However, in this path, the deallocation block 110 allocates the assigned resources. Thus, the execution machine 110 uses the resource represented by assigned batons during the second clock cycle 410b. The execution machine 130 frees up the resource and sends such an indication to the deallocation block 120 during the fourth clock cycle 410d or during a following clock cycle.

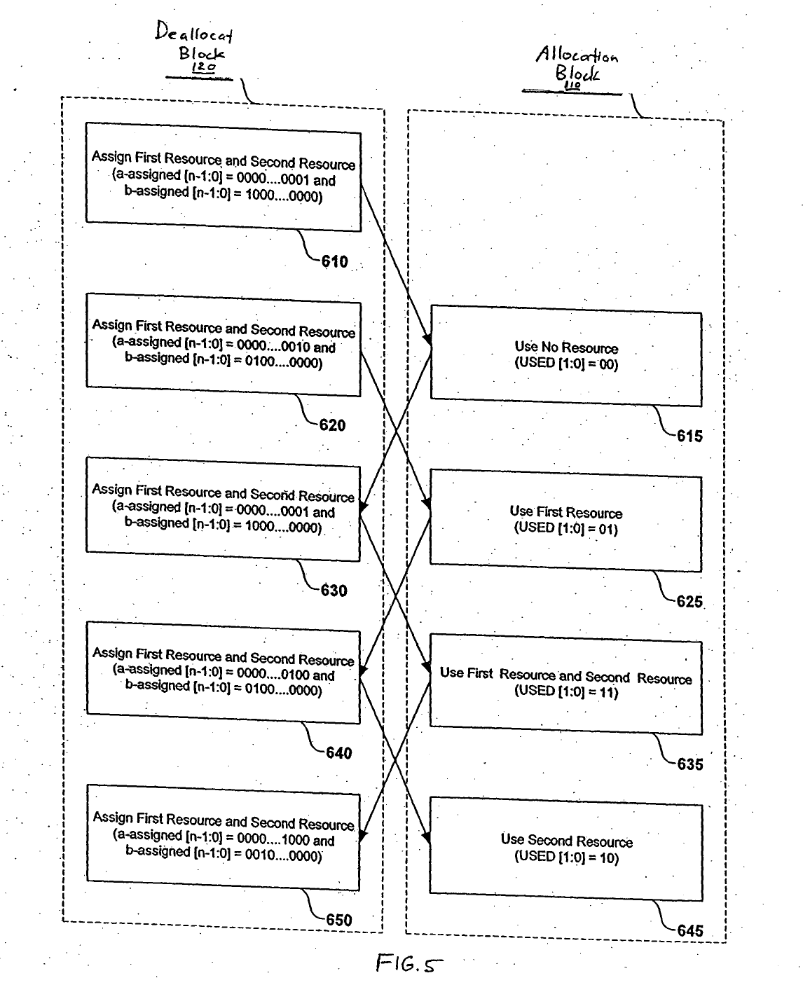

FIG. 5 is a flow chart of a method for baton passing in accordance with one embodiment of the present invention. The flow chart assumes that a the DECODE decides whether to use the baton or return it to the CRS during the same clock cycle.

In the first clock cycle, the deallocation block 120 assigns 610 a first resource and a second resource to the Allocation block 110. In the present embodiment, the deallocation block 120, in assigning resources, selects the first available entry from the top of the queue for the first resource and the first available entry from the bottom of the queue for the second resource. Specifically, regarding the first resource, a-assigned[n−1:0] is 0000 . . . 0001, and regarding the second resource b-assigned[n−1:0] is 1000 . . . 0000. The vector parameter n represents the total number of available resources (i.e., entry #n, entry #n−1, . . . entry #0). The bit number within [n−1:0] that is 1 indicates the entry number assigned. For example, if there are ten available resources, the vectors are expressed as a-assigned[9:0] and b-assigned[9:0]. In assigning entry #0 as the first resource, a-assigned[9:0] is 0000000001, and in assigning entry #9 as the second resource, b-assigned[9:0] is 1000000000.

In the second clock cycle, the deallocation block 120 assigns 620 a first resource and a second resource to Allocation block 110. Specifically, a-assigned[9:0] is 0000 . . . 0010 and b-assigned[9:0] is 0100 . . . 0000, since the deallocation block 120 assumes that the previously assigned first resource and second resource were used by the Allocation block 110 until receiving notification to the contrary. In the example of ten resources, a-assigned[9:0] is 0000000010 and b-assigned[0:0] is 0100000000. During the same clock cycle, the Allocation block 110 uses 615 no resource assigned during the first clock cycle. Specifically, USED[1:0], the 1:0 representing the resource used by the Allocation block 110, is 00 in returning the first resource and the second resource to the deallocation block 120.

In the third clock cycle, the deallocation block 120 assigns 630 a first resource and a second resource. Specifically, a-assigned[9:0] is 0000 . . . 0001 and b-assigned[9:0] is 1000 . . . 0000, since the deallocation block 120 has been notified that the first resource and the second resource assigned during the first clock cycle were not used by the Allocation block 110, and assumes that the first resource and the second resource assigned during the second clock cycle were used. In the example of ten resources, a-assigned[9:0] is 0000000001 and b-assigned[0:0] is 1000000000. During the same clock cycle, the Allocation block 110 uses 625 the first resource assigned during the second clock cycle. Specifically, USED [1:0] is 01 in returning the second resource to the deallocation block 120.

In the fourth clock cycle, the deallocation block 120 assigns 640 a first resource and a second resource. Specifically, a-assigned[9:0] is 0000 . . . 0100 and b-assigned[9:0] is 0100 . . . 0000, since the Deallocation block 120 has been notified that the second resource assigned during the second clock cycle was not used by the Allocation block 110, and assumes that the first resource and the second resource assigned during the third clock cycle were used. In the example of ten resources, a-assigned[9:0] is 0000000100 and b-assigned[0:0] is 0100000000. During the same clock cycle, the Allocation block 110 uses 625 the first resource and the second resource assigned during the third clock cycle. Specifically, USED[1:0] is 11 in returning neither resource to the Deallocation block 120.

In the fifth clock cycle, the Deallocation block 120 assigns 650 a first resource and a second resource. Specifically, a-assigned[9:0] is 0000 . . . 1000 and b-assigned[9:0] is 0010 . . . 0000, since the Deallocation block 120 has been notified that the first resource assigned during the third clock cycle were used by the Allocation block 110, but assumes that the first resource and the second resource assigned during the fourth clock cycle were used. In the example of ten resources, a-assigned[9:0] is 0000001000 and b-assigned[0:0] is 0010000000. During the same clock cycle, the Allocation block 110 uses 635 the first resource assigned during the fourth clock cycle. Specifically, USED[1:0] is 10 in returning the second resource to the Deallocation block 120.

In another embodiment, the Allocation block 110 notifies the Deallocation block 120 of unused resources with an UNUSED[n−1:0] vector. During the second clock cycle, in which the Allocation block 110 uses 615 no resource assigned during the first clock cycle, UNUSED[n−1:0] is 1000 . . . 0001. In the example of ten resources, UNUSED[n−1:0] is 1000000001. During the third clock cycle, in which the Allocation block 110 uses 625 the first resource assigned during the second clock cycle, UNUSED[n−1] is 0100 . . . 0000. In the example of ten resources, UNUSED[n−1:0] is 0100000000. During the fourth clock cycle, in which the Allocation block 110 uses 635 the first resource and the second resource assigned during the third clock cycle, UNUSED[n−1] is 0000 . . . 0000. In the example often resources, unused[n−1:0] is 0000000000. During the fifth clock cycle, in which the Allocation block 110 uses 645 the second resource assigned during the fourth clock cycle, UNUSED[n−1] is 0000 . . . 0100. In the example of ten resources, UNUSED [n−1:0] is 0000000100.

Advantageously, the present invention avoids time of flight delays associated with high clock rate systems having a single allocation/deallocation block. While particular embodiments and applications of the present invention have been illustrated and described, it is to be understood that the invention is not limited to the precise embodiments disclosed herein. Various modifications and variations will be apparent to those skilled in the art. These modifications and variations may be made in the arrangement, operation and details of the method and apparatus of the present invention disclosed herein without departing from the spirit and scope of the invention as defined in the following claims.

We claim:

1. In a processor, a distributed resource allocation system for dynamically allocating a plurality of resources, comprising:
a deallocation block for assigning a first available resource and sending a notification of the assignment, during a first clock cycle; and
an allocation block, at a location distributed from the deallocation block, for allocating the first available resource to an execution machine responsive to performing a task utilizing the first available resource, during a second clock cycle.

2. The system of claim 1, wherein the allocation block further returns the first available resource to the deallocation block during a third clock cycle responsive to not utilizing the first available resource, during the second clock cycle.

3. The system of claim 1, wherein the allocation block sends a second available resource to the deallocation block during the first clock cycle responsive to not utilizing the second available resource, during the first clock cycle.

4. The system of claim 1, wherein the allocation block and an allocation control point associated with the execution machine are located physically proximate to each other.

5. The system of claim 1, wherein the deallocation block is located physically proximate to a deallocation control point associated with the execution machine and the deallocation block receives the first available resource responsive to the deallocation control point freeing up a resource, during a third clock cycle.

6. The system of claim 1, wherein the deallocation block further includes OR and AND logic blocks and the first available resource is represented by a unary vector determined by the logic blocks.

7. In a processor, a distributed resource allocation system for dynamically allocating a plurality of resources, comprising:
a deallocation means for assigning a first available resource and sending a notification of the assignment, during a first clock cycle; and
an allocation means, at a location distributed from the deallocation means, for allocating the first available resource to an execution means responsive to performing a task utilizing the first available resource, during a second clock cycle.

8. The system of claim 7, wherein the allocation means further returns the first available resource to the deallocation agent during a third clock cycle responsive to not utilizing the first available resource, during the second clock cycle.

9. The system of claim 7, wherein the allocation means sends a second available resource to the deallocation means during the first clock cycle responsive to not utilizing the second available resource, during the first clock cycle.

10. The system of claim 7, wherein the allocation means and the execution machine are located physically proximate to each other.

11. The system of claim 7, wherein the deallocation means receives the first available resource responsive to the execution means completing the task, during a third clock cycle.

12. The system of claim 7, wherein the deallocation means comprises a central reservation station.

13. The system of claim 7, wherein the allocation means is a DECODE.

14. The system of claim 7, wherein the execution means comprises an arithmetic logic unit.

15. The system of claim 7, wherein the resource is one from the group consisting of: a buffer, a reorder buffer, a cache, and a memory element.

16. In a processor, a method for distributing resource allocation from resource deallocation, comprising:
assigning a first available resource and sending a notification of the assignment, at a first location, during a first clock cycle; and
allocating the first available resource responsive to performing a task utilizing the first available resource, at a second location distributed from the first location, during a second clock cycle.

17. The method of claim 16, further comprising returning the first available resource to the first location during a third clock cycle responsive to not utilizing the first available resource, during the second clock cycle.

18. The method of claim 16, further comprising sending a second available resource to the first location from the second location during the first clock cycle responsive to not utilizing the second available resource, during the first clock cycle.

19. A method of claim 16, further comprising executing the task.

20. A distributed resource allocation system in a processor capable of issuing more instructions than available resources, wherein each instruction uses an available resource, comprising:
a centralized reservation station for deallocating freed resources and continuously assigning a plurality of available resources to an allocation block independent of the allocation block's current need for available resources; and
the allocation block, decoupled from the allocation block, for allocating the assigned plurality of resources as needed to an execution machine and sending remaining assigned resources to the deallocation block; and
the execution machine for performing a task based on an instruction and, responsive to completing the task, notifying the deallocation unit of freed resources.
